(19) United States
(12) Patent Application Publication
(10) Pub. No.: US 2025/0182958 A1
(43) Pub. Date: Jun. 5, 2025

(54) POWER TRANSFORMER ASSEMBLY

(71) Applicant: BRUSA ELEKTRONIK AG, Buchs (CH)

(72) Inventor: Veit PFÄTTISCH, Ingolstadt (DE)

(21) Appl. No.: 18/843,461

(22) PCT Filed: Mar. 2, 2023
(86) PCT No.: PCT/EP2023/055258

§ 371 Date: Sep. 3, 2024

(30) Foreign Application Priority Data
Mar. 3, 2022 (CH) CH000220/2022

(51) Int. Cl. H01F 27/40; B60L 53/122; B60L 53/302; H01F 27/08

(52) U.S. Cl. CPC H01F 27/40; B60L 53/122; B60L 53/302; H01F 27/08; B60L 2210/30; H01F 2027/408

(57) ABSTRACT

The invention relates to a power transformer assembly to transform electromagnetic power of an oscillating electromagnetic field into electric power of an electric current or available electric current to charge an electric storage device or energize an electric load. The power transformer assembly includes: a magnetic assembly to receive the oscillating electromagnetic field and transform the oscillating electromagnetic field into an electric alternating current; an electronic assembly to receive the electric alternating current and transform the electric alternating current into the electric current; and a heat dissipation means for dissipating heat associated with one or more power transforming operations of the power transformer assembly, wherein the heat dissipation means includes a first heat transfer portion associated with the electronic assembly to dissipate heat generated at least by the electronic assembly.

### CROSS-REFERENCE TO RELATED APPLICATIONS

The present application is the U.S. National Phase of PCT/EP2023/055258, filed on 2 Mar. 2023, which claims priority to Swiss Patent Application No. CH000220/2022, filed on 3 Mar. 2022, the entire contents of which are incorporated herein by reference.

### BACKGROUND

### Field

The present invention relates to a power transformer assembly for transforming electromagnetic power of an oscillating electromagnetic field into electric power of an electric current or available electric current for charging an electric storage device or energizing an electric load.

### Related Art

The power transformer assembly includes a magnetic assembly for receiving the oscillating electromagnetic field and transforming it into an electric alternating current, and an electronic assembly for receiving the electric alternating current and transforming it into the electric current or available electric current. The power transformer assembly further includes heat dissipation means for dissipating heat generated by the electronic assembly during their respective power transforming operation.

The power transformer assembly, also referred to as a wireless charger module, may be used for charging a high-voltage (HV) battery of a vehicle. Such a module, sometimes also referred to as car-pad module (CPM), can receive an oscillating magnetic field from an external transmitter, which is sometimes referred to as ground-pad module (GPM), and transform the oscillating electromagnetic, predominantly magnetic field, into an alternating current which is converted (typically rectified) into an electric current (typically a direct current) used for charging the HV battery.

Batteries of electric vehicles can be charged using alternating current (AC) or direct current (DC) energy transfer. DC energy transfer is typically provided using high-power converters which are placed at dedicated charging points. While DC charging is typically faster than AC charging, it is not convenient for the end user as DC charging points are typically placed in remote areas and not installed in houses or residential areas as the installation of a DC charging point is expensive and the preexisting network capacity in those areas is usually vulnerable.

AC charging on the other hand is very important for residential areas and (semi) public urban areas. Typical AC chargers are capable of providing a charging power of up to 22 kW. AC charging systems can be divided into wired charging systems and wireless charging systems, wherein wireless charging systems are mainly embodied as inductive charging systems (ICSs). Wired AC chargers are typically integrated in electric vehicles and are also referred to as on-board chargers. An ICS typically includes two separate modules which are often referred to as ground-pad module (GPM) and car-pad module (CPM).

The GPM is installed outside the electric vehicle while the CPM is installed in the electric vehicle, usually at the bottom side of the vehicle. Electromagnetic interaction between the GPM and the CPM enables energy transfer from the GPM to the CPM, and the CPM is in turn used for charging a battery of the electric vehicle. Wireless charging systems are often more convenient for a user as typically no manual intervention is required for starting the charging process of the battery other than parking and positioning the vehicle above the GPM. Wired charging systems on the other hand require the user to connect the electric vehicle to a utility grid via a cable.

When it comes to cooling, it is important to understand that a CPM has two regions of heat generation: (a) the electronic assembly (power electronics) generating a lot of heat, but relatively concentrated at specific locations (high density), and (b) the magnetic assembly (coil and ferrite) generating less and relatively well distributed heat (low density). Prior art cooling systems for such CPMs are not well tailored to these circumstances and are relatively difficult to manufacture and thus expensive.

### SUMMARY

Therefore, it is an object of the invention to provide a power transformer assembly with improved overall cooling and, in particular, with improved electronic assembly cooling.

This object is achieved by a power transformer assembly for transforming electromagnetic power of an oscillating electromagnetic field into electric power of an electric current or available electric current for charging an electric storage device or energizing an electric load, the power transformer assembly including:
a magnetic assembly for receiving the oscillating electromagnetic field and transforming it into an electric alternating current;
an electronic assembly for receiving the electric alternating current and transforming it into the electric current or available electric current; and
heat dissipation means for dissipating heat generated by the electronic assembly during their respective power transforming operation, characterized in that the heat dissipation means includes a first heat transfer portion associated to the electronic assembly.

This first heat transfer portion allows concentrated heat from specific locations of the electronic assembly to be removed from the electronic assembly.

Heat transfer from the electronic assembly may be a combination of (heat) radiation, (heat) conduction and (heat) convection.

Preferably, the first heat transfer portion is in thermal contact with the electronic assembly. As a result, heat transfer from the electronic assembly is due more to heat conduction than to heat radiation. Heat transferred by conduction can be better contained while being channeled away from the electronic assembly than heat transferred by radiation.

Typically, the electronic assembly includes power electronics, preferably with several power electronics components such as diodes, thyristors and power transistors (MOSFETs and/or IGFTs).

In a preferred embodiment, an arrangement of electronic components of the electronic assembly extends along a first smoothened imaginary reference surface within a first volume defined by the first imaginary reference surface and a first imaginary thickness extending in a direction orthogonal to the first reference surface.

Preferably, the first smoothened imaginary reference surface includes at least one of a planar surface portion, a surface portion with a one-dimensional curvature and a surface portion with a two-dimensional curvature, thus defining a plate-like and/or shell-like first volume having an edge-like circumferential periphery and including the electronic assembly.

With all the heat generated by the electronic assembly originating from this plate-like or shell-like first volume, the distance from any point within the first volume to a closest boundary point of the first volume is very short. The maximum such distance would be half the first volume thickness if either one of the two large boundary surfaces can be chosen for the boundary point. The maximum such distance would be one (entire) first volume thickness if only one of the two large boundary surfaces can be chosen for the boundary point. As a result, thermal resistance within the imaginary first volume around the electronic assembly is low, and heat generated by the electronic assembly is easily removed from the electronic assembly by heat conduction.

Preferably, the heat dissipation means includes a second heat transfer portion associated to the magnetic assembly.

This second heat transfer portion allows less and relatively well distributed heat (less concentrated heat) from specific locations of the magnetic assembly to be removed from the magnetic assembly.

Again, heat transfer from the magnetic assembly may be a combination of (heat) radiation, (heat) conduction and (heat) convection.

Preferably, the second heat transfer portion is in thermal contact with the magnetic assembly. Again, as a result, heat transfer from the magnetic assembly is due more to heat conduction than to heat radiation. Heat transferred by conduction can be better contained while being channeled away from the magnetic assembly than heat transferred by radiation.

In a further preferred embodiment, a coil topology of the magnetic assembly extends along a second smoothened imaginary reference surface within a second volume defined by the second imaginary reference surface and a second imaginary thickness extending in a direction orthogonal to the second reference surface.

Preferably, the second smoothened imaginary reference surface includes at least one of a planar surface portion, a surface portion with a one-dimensional curvature and a surface portion with a two-dimensional curvature, thus defining a plate-like and/or shell-like second volume having an edge-like circumferential periphery and including the magnetic assembly.

Again, with all the heat generated by the magnetic assembly originating from this plate-like or shell-like second volume, the distance from any point within the second volume to a closest boundary point of the second volume is very short. The maximum such distance would be half the second volume thickness if either one of the two large boundary surfaces can be chosen for the boundary point. The maximum such distance would be one (entire) second volume thickness if only one of the two large boundary surfaces can be chosen for the boundary point. As a result, thermal resistance within the imaginary second volume around the magnetic assembly is low, and heat generated by the magnetic assembly is easily removed from the magnetic assembly by heat conduction.

In a still further preferred embodiment, the heat dissipation means includes a coolant circuit with the first heat transfer portion being a portion of the coolant circuit.

This coolant circuit allows concentrated heat, originating from the electronic assembly and removed from the electronic assembly primarily by conduction, to be further removed by forced convection, i.e., by a cooling fluid pumped through the coolant circuit.

Preferably, the electronic assembly and the first volume surrounding it is located adjacent to the edge-like circumferential periphery of the second volume including the magnetic assembly.

This first-volume/second volume edge-to-edge adjacent arrangement, i.e., nonstacked arrangement, of the electronic assembly and the magnetic assembly contributes to the overall small thickness of the entire power transformer assembly. As a result, a ground-pad module (GPM) including such power transformer assembly will also have a small thickness, thus keeping a low profile when fitted to the bottom side of an electric vehicle.

Preferably, the coolant circuit extends along at least a portion of the edge-like circumferential periphery of the second volume including the magnetic assembly. This contributes to the compactness of a ground-pad module (GPM) including such power transformer assembly, again making it easier for a GPM to be fitted to the bottom side of an electric vehicle.

In an even further preferred embodiment, the first heat transfer portion extends along a third smoothened imaginary reference surface within a third volume defined by the third imaginary reference surface and a third imaginary thickness extending in a direction orthogonal to the third reference surface.

Preferably, the third smoothened imaginary reference surface includes at least one of a planar surface portion, a surface portion with a one-dimensional curvature and a surface portion with a two-dimensional curvature, thus defining a plate-like and/or shell-like third volume having an edge-like circumferential periphery and including the first heat transfer portion.

With all the heat originating from the electronic assembly, i.e., from the first volume, and entering the first heat transfer portion, i.e., into the third volume, the distance from any point within the third volume to a closest boundary point of the third volume is very short. The maximum such distance would be half the second volume thickness if either one of the two large boundary surfaces can be chosen for the boundary point. The maximum such distance would be one (entire) second volume thickness if only one of the two large boundary surfaces can be chosen for the boundary point. As a result, thermal resistance within the imaginary third volume around the first heat transfer portion is low, and heat generated by the electronic assembly is easily removed from the electronic assembly by heat conduction and forced convection within the first heat transfer portion, i.e., within the third volume.

In another preferred embodiment, a) the arrangement of electronic components of the electronic assembly extending within the first volume defined by the first imaginary reference surface and the first imaginary thickness orthogonal to the first reference surface, on the one hand, and b) the first heat transfer portion extending within the third volume defined by the third imaginary reference surface and the third imaginary thickness orthogonal to the third reference surface, on the other hand, are thermally associated to each other.

Preferably, a) the arrangement of electronic components of the electronic assembly and b) the first heat transfer portion are arranged in stacked relationship adjacent to each other with third the first imaginary reference surface and the third imaginary reference surface close to each other.

The electronic assembly, corresponding to the first volume, and the first heat transfer portion, corresponding to the third volume, are stacked plates (planar) or stacked shells (curved).

Irrespective of their geometries (planar or curved), this compact stacked relationship of the electronic assembly and the first heat transfer portion improves the heat transfer between the electronic assembly and the first heat transfer portion which may be a portion of a coolant circuit.

Preferably, said first heat transfer portion is a duct portion of the coolant circuit. As already mentioned above, this allows heat from the electronic assembly to be efficiently removed by conduction and forced convection.

Preferably, the duct portion includes a plurality of protrusions extending in a direction transverse to a main coolant flow direction within the duct portion.

Preferably, the plurality of protrusions is rooted in a first inner wall of the duct portion and extends towards a second inner wall, opposite to the first inner wall, of the duct portion.

Preferably, the plurality of protrusions are pin-like formations.

All this contributes to increased surface area for the coolant/duct portion interface, thus increasing heat flow across this interface, i.e., from the electronic assembly to the duct portion and to the coolant within the duct portion.

Preferably, the protrusions each have a protrusion axis, wherein the protrusion axes of all protrusions are parallel to each other.

Preferably, the protrusions each are tapered with their cross section diminishing along a protrusion axis from a greater cross section at a protrusion root portion to a smaller cross section at a protrusion tip portion.

The tapered protrusions may be truncated cones (frusto-conical shape) or truncated pyramids (frusto-pyramidal shape).

All this contributes to improved demoldability of molded parts if such parts of the protrusion-equipped duct portion are made by molding such as injection molding or die casting.

Preferably, a protrusion of the plurality of protrusions has a cross section selected from at least one of circular, oval, elliptical and polygonal.

Preferably, the cross section is a regular hexagon or a lozenge (diamond).

All these cross-sectional shapes help prevent dead zones from forming within the coolant flow. Again, this contributes to increased surface area for the coolant/duct portion interface, thus increasing heat flow across this interface, i.e., from the electronic assembly to the duct portion and to the coolant within the duct portion.

Preferably, the plurality of protrusions comprises protrusions having different shapes and/or different sizes.

This allows free spaces between larger protrusions to be partially filled by smaller protrusions which again increases surface area for the coolant/duct portion interface, but also reduces the effective duct cross section for coolant flow. As a result, both cooling performance and coolant pressure drop along the duct portion can be adjusted by changing at least one of protrusion size, protrusion shape, and protrusion packing density.

Preferably, the protrusions of the plurality of protrusions are staggered with respect to the main flow direction.

This helps prevent dead zones from forming within the coolant flow and, in addition, prevents short-circuiting with the coolant flow pattern.

Preferably, a) a first plurality of protrusions of the plurality of protrusions are rooted in a first inner wall of the duct portion and extend towards a second inner wall, opposite to the first inner wall, of the duct portion; and b) a second plurality of protrusions of the plurality of protrusions are rooted in the second inner wall of the duct portion and extend towards the first inner wall, opposite to the second inner wall, of the duct portion.

Again, this helps prevent dead zones from forming within the coolant flow and, in addition, prevents short-circuiting with the coolant flow pattern.

Also, if the duct portion or the entire coolant circuit with the duct portion are made by molding, this allows the duct portion or the entire coolant circuit to be made from two identical parts or “halves” which can be fitted together to obtain the duct portion or the coolant circuit.

Preferably, a length of each of the protrusions along the protrusion axis is smaller than or equal to a duct width along the protrusions axis between the first inner wall and the opposite second inner wall.

This allows for manufacturing tolerance compensation, thus preventing any of the protrusions from being too long and which may block the fitting together of two complementary molded parts of the duct portion or the entire coolant circuit.

Preferably, the protrusions are hollow.

This not only reduces the weight of the duct portion or the entire coolant circuit, but also reduces the amount of material required for making the duct portion or the entire coolant circuit. In addition, the hollow spaces of the hollow protrusions lend themselves to providing fixing means such as fixing screws or bolts extending within the hollow protrusions, preferably along a protrusion axis and through a hole at the tip of the protrusion.

Preferably, the coolant circuit with the first heat transfer portion is made by forming (shaping) a material in a mold.

Preferably, the coolant circuit with the first heat transfer portion is made by molding (casting, injecting) a moldable material within or into the mold.

Preferably, the coolant circuit with the first heat transfer portion is made by sintering a sinterable material within the mold.

Preferably, the coolant circuit with the first heat transfer portion is made by crosslinking a cross-linkable material within the mold.

Preferably, the coolant circuit with the first heat transfer portion is made additively in a layer-by-layer fashion.

### BRIEF DESCRIPTION OF THE DRAWINGS

FIG. 1 shows a top view of a cut-away portion of a power transformer assembly according to the invention.

FIG. 2 shows a perspective view of a first part (bottom part comprising protrusions) of the cut-away portion of the power transformer assembly of FIG. 1.

FIG. 3 shows a perspective view of a second part (top part without protrusions) of the cut-away portion of the power transformer assembly of FIG. 1.

FIG. 4 shows a first cross section, perpendicular to a coolant main flow direction, of the cut-away portion of the power transformer assembly of FIG. 1.

FIG. 5 shows a second cross section, perpendicular to a coolant main flow direction, of the cut-away portion of the power transformer assembly of FIG. 1.

### DETAILED DESCRIPTION

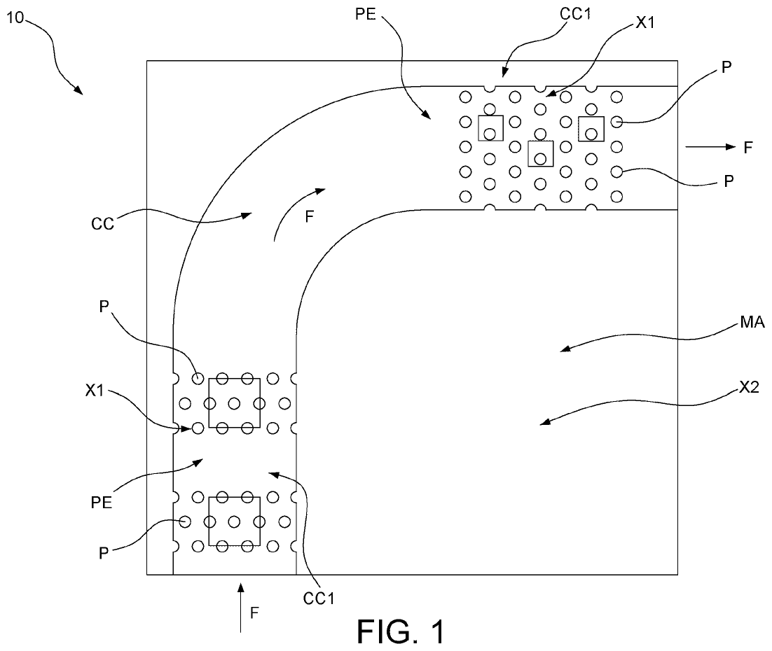

FIGS. 1-5 show an embodiment of a power transformer assembly 10 according to the invention.

FIG. 1 shows a top view of a cut-away portion of the power transformer assembly 10. The power transformer assembly 10 is configured to transform electromagnetic power of an oscillating electromagnetic field into electric power of an electric current or available electric current for charging an electric storage device or energizing an electric load. In particular, the power transformer assembly 10 includes: a magnetic assembly MA configured to receive the oscillating electromagnetic field and transform the oscillating electromagnetic field into an electric alternating current AC; an electronic assembly PE configured to receive the electric alternating current AC and transform the AC into the electric current; and a heat dissipation means configured to dissipate heat generated by the electronic assembly PE during their respective power transforming operation, wherein the heat dissipation means includes a first heat transfer portion X1 that is associated with the electronic assembly PE and can further include a second heat transfer portion X2 that is associated with the magnetic assembly MA.

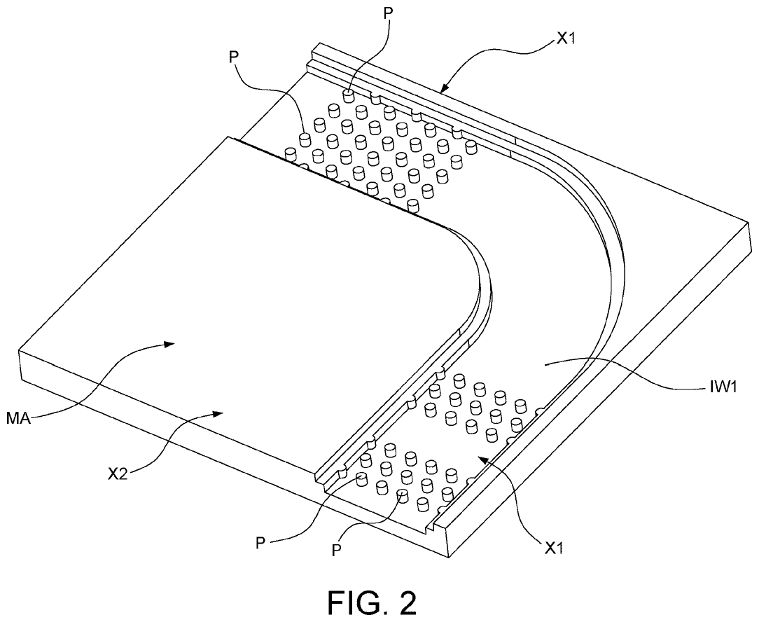

The first heat transfer portion X1 includes a coolant circuit CC configured to allow concentrated heat, originating from the electronic assembly PE and removed from the electronic assembly PE primarily by conduction, to be further removed by forced convection, i.e., by a cooling fluid pumped through the coolant circuit CC. The coolant circuit CC includes one or more duct portions CC1. A duct portion CC1 includes a plurality of protrusions P that extend in a direction transverse to a main coolant flow direction F within the duct portion CC1. The plurality of protrusions P can be rooted in a first inner wall IW1 of the duct portion CC1 and extend towards a second inner wall IW2, opposite to the first inner wall IW1, of the duct portion CC1. As described with reference to FIG. 2, the second inner wall IW2 can include openings that are reciprocal to the protrusions P of the first inner wall IW1, such that the protrusions P of the first inner wall IW1 can friction fit the openings of the second inner wall IW2, thus enclosing the duct portions CC1 of the coolant circuit CC between the inner walls IW1 and IW2.

The plurality of protrusions P can also include protrusions that are rooted in the first inner wall IW1 of the duct portion CC1 and in the second inner wall IW2 of the duct portion CC1. In particular, a first plurality of protrusions of the plurality of protrusions P can be rooted in a first inner wall IW1 of the duct portion CC1 and extend towards the second inner wall IW2, opposite to the first inner wall IW1, of the duct portion CC1. Moreover, a second plurality of protrusions of the plurality of protrusions P can be rooted in the second inner wall IW2 of the duct portion CC1 and extend towards the first inner wall IW1, opposite to the second inner wall IW2, of the duct portion CC1. Similarly, reciprocal openings can be provided in the inner walls IW1, IW2.

The plurality of protrusions P can be staggered with respect to the main flow direction F within the duct portion CC1, as shown in FIGS. 1 and 2, for example. This can particularly prevent dead zones from forming within the coolant flow and can further prevent short-circuiting with a coolant flow pattern.

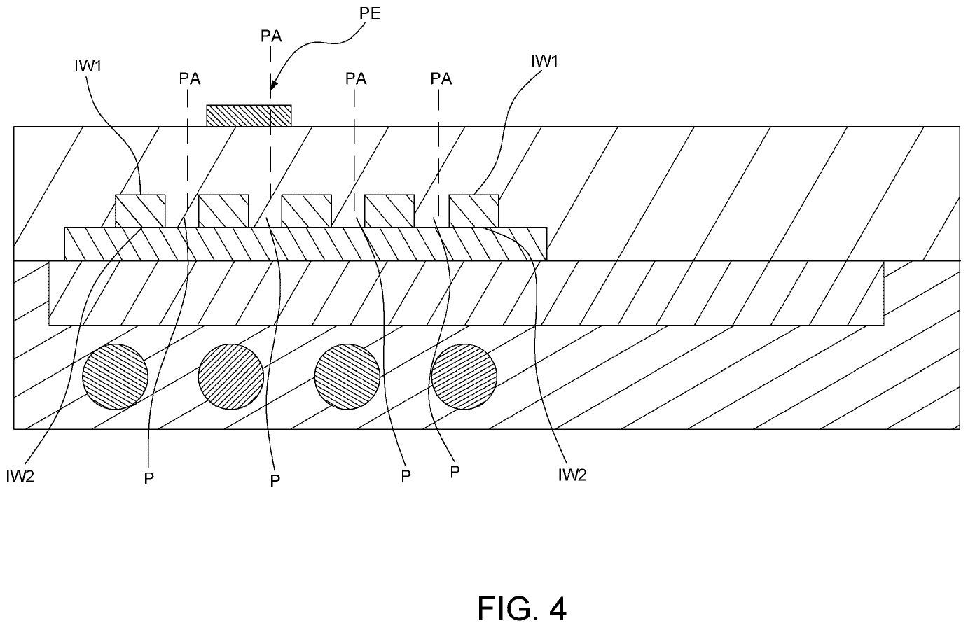

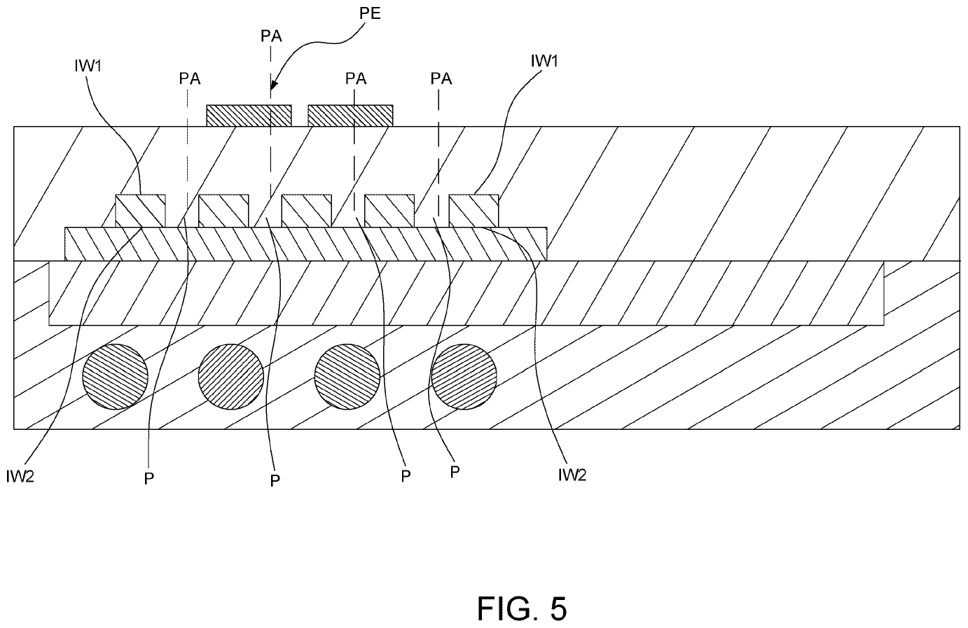

The plurality of protrusions P can include protrusions having different shapes and/or different sizes. In some cases, a protrusion can be a pin-like formation, such as shown in FIG. 2. Moreover, a protrusion can have a protrusion axis PA, as shown in FIGS. 4 and 5, wherein protrusion axes PA of protrusions P can be parallel to each other (e.g., cylindrical formations about axes PA with a circular cross-section).

In some cases, a protrusion can be tapered with its cross section diminishing along the protrusion axis PA from a greater cross section at a protrusion root portion to a smaller cross section at a protrusion tip portion. For example, the protrusion can take a shape of a truncated cone, frusto-conical or truncated pyramid, or frusto-pyramidal pyramid. In other cases, the protrusion can have a cross section selected from at least one of oval, elliptical, polygonal, hexagonal, or diamond.

A length of each of the protrusions P along the protrusion axis PA can be the smaller than or equal to a duct width along the protrusion axis PA between the first inner wall IW1 and the opposite second inner wall IW2 of the duct portion CC1. One or more of the protrusions P can be hollow.

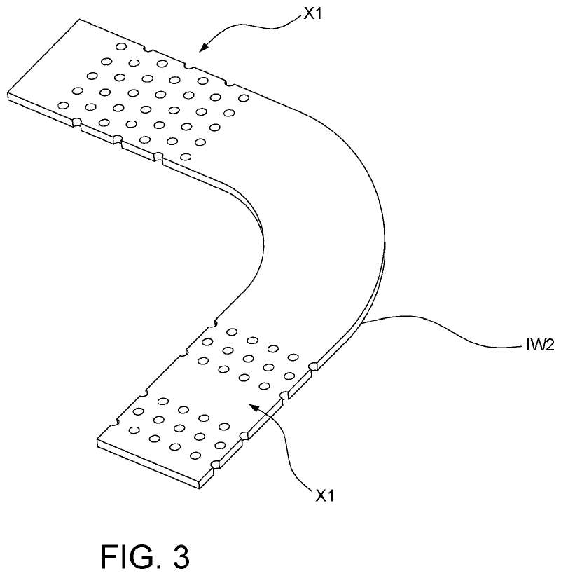

FIG. 2 shows a perspective view of a first part (bottom part comprising protrusions) of the cut-away portion of the power transformer assembly of FIG. 1, while FIG. 3 shows a perspective view of a second part (top part without protrusions) of the cut-away portion of the power transformer assembly of FIG. 1. In particular, the top part can be shaped similarly to the bottom part, and can include openings that are reciprocal to the protrusions of the bottom part, such that the first (bottom) part and the second (top) part can be combined together, such as by friction-fitting at least portions of the protrusions in the reciprocal openings so as to form the transformer assembly 10, as shown in FIG. 1, with duct portions CC1 of a duct of the coolant circuit CC enclosed by the bottom and top parts. Alternatively, the top part can omit the openings and can be shaped to be wider side to side than the duct such that it can be disposed or secured atop a shelf or step as shown in FIG. 2, and can be flush with a top surface of the power transformer assembly 10, with duct portions CC1 of the duct of the coolant circuit CC thus being enclosed by the bottom and top parts.

FIG. 4 shows a first cross section, perpendicular to a coolant main flow direction F, of the cut-away portion of the power transformer assembly 10 of FIG. 1, while FIG. 5 shows a second cross section, perpendicular to a coolant main flow direction F, of the cut-away portion of the power transformer assembly of FIG. 1. In FIG. 4, the power transformer assembly 10 shows one electronic assembly PE associated with the coolant circuit CC, while in FIG. 5, the power transformer assembly 10 shows several electronic assemblies PE associated with the coolant circuit CC.

1. A power transformer assembly to transform electromagnetic power of an oscillating electromagnetic field into electric power of an electric current or available electric current to charge an electric storage device or energize an electric load, the power transformer assembly comprising:
a magnetic assembly to receive the oscillating electromagnetic field and transform the oscillating electromagnetic field into an electric alternating current;
an electronic assembly to receive the electric alternating current and transform the electric alternating current into the electric current; and
a heat dissipation means for dissipating heat associated with one or more power transforming operations of the power transformer assembly, wherein the heat dissipation means comprises a first heat transfer portion (X1) associated with the electronic assembly (PE) to dissipate heat generated at least by the electronic assembly.

2. The power transformer assembly according to claim 1, wherein the first heat transfer portion is in thermal contact with the electronic assembly.

3. The power transformer assembly according to claim 1, wherein the electronic assembly comprises power electronics having one or more power electronics components.

4. (canceled)

5. (canceled)

6. The power transformer assembly according to claim 1, wherein the heat dissipation means comprises a second heat transfer portion associated with the magnetic assembly to dissipate heat generated at least by the magnetic assembly.

7. The power transformer assembly according to claim 6, wherein the second heat transfer portion is in thermal contact with the magnetic assembly.

8. (canceled)

9. (canceled)

10. The power transformer assembly according to any one of the claim 1, wherein the heat dissipation means comprises a coolant circuit with the first heat transfer portion being a portion of the coolant circuit.

11.-15. (canceled)

16. The power transformer assembly according to claim 1, wherein an arrangement of electronic components of the electronic assembly and the first heat transfer portion are arranged in stacked relationship adjacent to each other.

17. The power transformer assembly according to claim 10, wherein the first heat transfer portion is a duct portion of the coolant circuit.

18. The power transformer assembly according to claim 17, wherein the duct portion comprises a plurality of protrusions extending in a direction transverse to a main coolant flow direction within the duct portion.

19. The power transformer assembly according to claim 18, wherein the plurality of protrusions are rooted in a first inner wall of the duct portion and extend towards a second inner wall, opposite to the first inner wall (IW1), of the duct portion.

20. The power transformer assembly according to claim 18, wherein the plurality of protrusions are pin-like formations.

21. The power transformer assembly according to claim 20, wherein each of the protrusions has a protrusion axis and wherein protrusion axes of all protrusions are parallel to each other.

22. The power transformer assembly according to claim 18, wherein each of the protrusions is tapered with a cross section diminishing along a protrusion axis from a greater cross section at a protrusion root portion to a smaller cross section at a protrusion tip portion.

23. The power transformer assembly according to claim 18, wherein a protrusion of the plurality of protrusions has a cross section selected from at least one of circular, oval, elliptical, and polygonal.

24. The power transformer assembly according to claim 22, wherein the cross section is a regular hexagon or a diamond.

25. The power transformer assembly according to claim 18, wherein the plurality of protrusions comprises protrusions having different shapes and/or different sizes.

26. The power transformer assembly according to claim 18, wherein protrusions of the plurality of protrusions are staggered with respect to the main coolant flow direction.

27. The power transformer assembly according to claim 18, wherein;
a first plurality of protrusions of the plurality of protrusions is rooted in a first inner wall (IW1) of the duct portion and extends towards a second inner wall, opposite to the first inner wall, of the duct portion; and
a second plurality of protrusions of the plurality of protrusions is rooted in the second inner wall of the duct portion and extends towards the first inner wall, opposite to the second inner wall, of the duct portion.

28. The power transformer assembly according to claim 19, wherein a length of each of the protrusions along a protrusion axis is smaller than or equal to a duct width of the duct portion along the protrusions axis between the first inner wall and the opposite second inner wall.

29. The power transformer assembly according to claim 18, wherein the protrusions are hollow.

30.-34. (canceled)
